(19) United States
(12) Patent Application Publication
(10) Pub. No.: US 2007/0210620 A1
(43) Pub. Date: Sep. 13, 2007

(54) Roof opening system for motor vehicles

(76) Inventor: Michael Heidan, Wiesbaden (DE)

Correspondence Address: SHERIDAN ROSS PC, 1560 BROADWAY, SUITE 1200, DENVER, CO, 80202, US

(21) Appl. No.: 10/577,900

(22) PCT Filed: Oct. 28, 2004
(86) PCT No.: PCT/EP04/12216

§ 371 Date: Jan. 3, 2007

(30) Foreign Application Priority Data
Nov. 11, 2003 (DE) 10352914.4
Mar. 17, 2004 (DE) 102004014166.5

(51) Int. Cl. B60J 7/00

(52) U.S. Cl. 296/214; 296/223

(57) ABSTRACT

Disclosed is a roof opening system comprising at least one transparent or partly transparent vehicle cover (1) and at least one shade element (2) which independently of each other are movable in different positions. The roof opening system is characterized in that the movements are clearly made possible by only one electric drive (4). A manual operation of the at least one shade element (2) is not required.

The present invention relates to a roof opening system for automotive vehicles with one or several at least partly transparent vehicle covers and at least one shade element.

The prior art mainly discloses three embodiments of roof opening systems. The embodiment of a tilt/slide sunroof permits the opening/closing, pivoting and/or selective displacement of the vehicle cover into the interior of the vehicle. The embodiment of a pop-up roof permits the opening/closing and pivoting of the vehicle cover. The embodiment of a spoiler roof permits the opening/closing, pivoting and/or selective displacement of the vehicle cover outside the vehicle.

The prior art discloses roof opening systems with at least one transparent or partly transparent vehicle cover, e.g. glass cover type, which is operated by an electric drive. Moreover, some of these roof opening systems permit the partial operation of at least one shade element by the electric drive. A manual operation of the shade element, however, is still required for realizing positions of the shade element that are desired by the user. For instance, a manual operation is needed in some roof opening systems for closing the shade element out of an opened position.

Furthermore, roof opening systems are known with at least one opaque vehicle cover, e.g. sheet-metal cover type, which is operated by an electric drive. Moreover, some of these roof opening systems permit the operation of at least one shade element in all essential positions. A manual operation is not needed due to the system. The absence of at least one transparent or partly transparent vehicle cover considerably reduces the comfort of such systems.

Furthermore, roof opening systems are known with at least one transparent or partly transparent vehicle cover, e.g. glass cover type, which is operated by an electric drive. A further electric drive operates at least one shade element. A manual operation is not required due to the system. In these roof opening systems, the components vehicle cover and shade element are controlled by suitable control systems, e.g. control logic/control switch.

Moreover, the prior art discloses coupling and/or locking systems that permit a detachment of a first stationarily locked slide element, e.g. cover locking element, from the locked position in a stationary element, such as a rigid guide element, by coupling with a movably supported element, e.g. drive element. The locking plane can be freely chosen, adapted to external conditions. For locking purposes the stationary element must comprise at least one receiving means for a form/friction/force closure and/or at least one stop.

It is the object of the present invention to overcome the drawbacks of the prior art.

This object is achieved with a roof opening system according to claim 1. Advantageous embodiments can be found in the subclaims.

The present invention provides a roof opening system for a vehicle that is equipped with only one electric drive for operating at least one transparent or partly transparent vehicle cover for opening/closing a roof opening, for selectively displacing and/or pivoting the transparent or partly transparent vehicle cover and for operating at least one shade element for opening/closing. For enhancing the comfort of the roof opening system a manual operation of the shade element is avoided.

The roof opening system of the invention is reliable, efficient, user-friendly, secure, lightweight, easy to mount and maintain and inexpensive.

The roof opening system according to the invention for a vehicle is characterized in that at least one transparent or partly transparent vehicle cover and at least one shade element, which are each movable within wide ranges independently of each other within the opening area provided for, are operated with only one electric drive. A manual operation of the shade element is not required.

The present invention is not restricted to tilt/slide sunroofs in the case of which the vehicle cover is moved underneath the vehicle roof and into the interior of the vehicle. Rather, the described invention relates to all roof opening systems, e.g. pop-up roofs, tilt/slide sunroofs and spoiler roofs that are sufficiently known from the prior art and have at least one vehicle cover and at least one shade element.

The invention has the advantage to be of great benefit to the customer, which has so far not been achieved. It permits the movement of the vehicle cover and of the shade element with only one electric drive and thus without manual operation.

Furthermore, the roof opening concept simplifies possible operation concepts.

An essential advantage is also the reduced risk of injury because a manual operation of the shade element is dispensed with. Incidental jamming, caused by the manual operation of the roof opening system, is thus avoided.

The absence of a manual operation of the shade element is of advantage, beyond the existing legal rules, because the use of a grip or grip plate is no longer needed.

A further important advantage is enhanced road safety because objectionable factors due to the manual operation of, for instance, the shade element can be avoided.

An essential advantage is the reduced weight in comparison with the roof opening systems known from the prior art, which comprise two electric drives. This entails a considerable cost advantage in comparison with the roof opening systems known from the prior art with almost the same benefit due to considerable component reduction.

In comparison with the roof opening systems known from the prior art, the increased comfort created by more headroom for the passengers, which is achieved through the omission of the second electric drive, is of advantage.

In comparison with the roof opening systems known from the prior art, the invention has the advantage that the roof opening system according to the invention can be integrated into existing systems by a mechanical modification in the case of which the essential components are maintained.

A further advantage of the roof opening system of the invention is the possibility of enlarging or combining further functional elements of roof opening systems, e.g. water management and/or air deflector concepts.

The small number of parts is of advantage in comparison with existing roof opening systems having almost the same functionality. This entails reduced assembly and maintenance efforts.

In a particularly preferred embodiment, the roof opening system for automotive vehicles comprises at least one transparent vehicle cover and at least one shade element which are movable with only one electric device, depending on the design, either fully and/or partly independently of each other over the whole opening area provided in the vehicle.

In a particularly preferred variant, the movements of at least one transparent vehicle cover and at least one shade element take place along at least one rigid guide element.

In a further particularly preferred variant, at least one transparent vehicle cover moves relative to at least one rigid guide element.

In an advantageous embodiment, the electric drive has only one respective direction of rotation in the movement cycle opening and in the movement cycle closing of at least one transparent vehicle cover and at least one shade element.

Advantageously, the roof opening system has exactly three coupling and/or locking operations for a respective movement cycle opening or closing of at least one transparent vehicle cover and/or at least one shade element.

In a possible embodiment, the vehicle cover can be made partly transparent.

Likewise, it is of advantage when at least one shade element comprises at least one shade guide.

In a particularly preferred embodiment, the shade guide is configured to be lockable in the rigid guide element and coupleable with at least one drive element.

Advantageously, at least one transparent vehicle cover is movably supported in at least one rigid guide element in the area of the front edge of the vehicle cover.

A further advantage arises when at least one transparent vehicle cover comprises at least one detachable fixed bearing.

Advantageously, at least one control rod is rotatably supported in at least one detachable fixed bearing of at least one transparent vehicle cover.

It is also of advantage when at least one control rod is rotatably supported in at least one vehicle-cover locking element.

In an advantageous variant of the invention, at least one vehicle-cover locking element is configured to be lockable in at least one rigid guide element and coupleable with at least one drive element.

A further advantage is when at least one control rod interacts in form-fit fashion with at least one vehicle-cover control element.

A further particular advantage exists if at least one vehicle-cover control element is slidably supported in at least one rigid guide element.

Advantageously, at least one vehicle-cover control element is configured to be lockable in at least one rigid guide element and coupleable with at least one drive element.

In a particular embodiment, at least one vehicle-cover control element comprises at least one control path.

In a further particular embodiment, the electric drive moves at least one drive element along at least one rigid guide element.

In a preferred embodiment, at least one drive element interacts by way of coupling and decoupling with at least one shade guide, at least one vehicle-cover control element and at least one vehicle-cover locking element.

In a further preferred embodiment, the control rod comprises a control path and the vehicle-cover control element interacts in form-fit fashion with the control rod.

In a particular variant, the roof opening system is used for tilt/slide sunroofs having at least one transparent or partly transparent vehicle cover and at least one shade element.

In a further particular variant, the roof opening system is used for pop-up roofs with at least one transparent or partly transparent vehicle cover and at least one shade element.

In a further preferred variant, the roof opening system is used for spoiler roofs having at least one transparent or partly transparent vehicle cover and at least one shade element.

In a particularly preferred variant, at least one shade element is configured as a rigid plate.

In a further particularly preferred variant, at least one shade element is configured as a flexible element.

In a preferred variant, the shade element is made opaque.

In a further particularly preferred variant, the shade element is made partly transparent.

A preferred embodiment is the coupling of at least one vehicle-cover locking element by at least one drive element.

A further preferred embodiment is the coupling of at least one vehicle-cover locking element by at least one vehicle-cover control element which, in turn, is coupled by at least one drive element.

In a preferred embodiment, the end of the drive cable that is not connected to the drive element is used for controlling an air deflector. Used for this is part of the displacement path of at least one drive element.

In a further preferred configuration, the roof opening system is capable of controlling known air deflector types, such as flap type air deflectors, lift type air deflectors, and grid type air deflectors.

Advantageously, the planes of the coupling and/or locking systems can be used freely, due to the installation space.

In a further preferred configuration, the roof opening system is capable of controlling known water management systems, such as water management systems supported on the vehicle cover, on the vehicle roof, or in the mechanical system.

In a preferred variant, comfortable operation concepts can be realized in the described roof opening system, e.g. comfort opening/closing by overriding a switch position.

A further special advantage is that with the present roof opening system according to the invention the overlap of the displacement paths of the vehicle cover on the one hand and of the shade element on the other hand can be selected in any desired way in the constructional design between synchronous movement and no overlap at all. It is thereby possible to adapt the roof opening system of the invention to almost all possible vehicle types with the most different needs.

A further particularly preferred embodiment is that the present roof opening system of the invention requires exactly two coupling and/or locking processes for a respective movement cycle opening or closing of at least one transparent vehicle cover and/or at least one shade element.

A particular advantage is that the movements of at least one transparent vehicle cover and at least one shade element take place along at least one rigid guide element.

A further special advantage is that at least one shade element comprises at least one shade guide.

A further advantage is that the shade guide is configured to be lockable in the rigid guide element and coupleable with at least one drive element.

The at least one vehicle cover is advantageously connected to at least one vehicle-cover connection element.

In a preferred variant, at least one path element is guided in the at least one rigid guide element.

In a particularly preferred variant, a vehicle-cover locking element is part of the at least one path element.

An advantage is that the at least one path element includes at least one cover movement path.

A further advantage is that at least one vehicle-cover locking element is made lockable in the at least one rigid guide element.

A further particular advantage is that the at least one vehicle-cover locking element is made coupleable with the at least one drive element.

In an advantageous variant, the at least one vehicle-cover connection element with at least one slide bolt and at least one control bolt is guided in form-fit fashion in at least one cover movement path.

In a particularly advantageous variant, the at least one control bolt is guided in form-fit fashion in the at least one rigid guide element and in at least one cover control path.

In a further particularly advantageous configuration, the at least one path element is a multi-part element.

In another particularly preferred configuration, the at least one slide bolt and the at least one control bolt are configured as levers.

In a further particularly preferred embodiment, the at least one cover control path is part of the at least one rigid guide element.

In a particularly preferred variant, the at least one vehicle-cover locking element is configured as a separate part.

In a further particularly preferred variant, the at least one control bolt is part of the at least one vehicle-cover connection element.

In a particularly preferred embodiment, the at least one slide bolt is part of the at least one vehicle-cover connection element.

In a further particularly preferred embodiment, the at least one cover movement path is part of the at least one vehicle-cover connection element.

In the drawing, the subject matter of the invention is schematically shown and will be described hereinafter with reference to the figures, elements of equal action being provided with the same reference numerals.

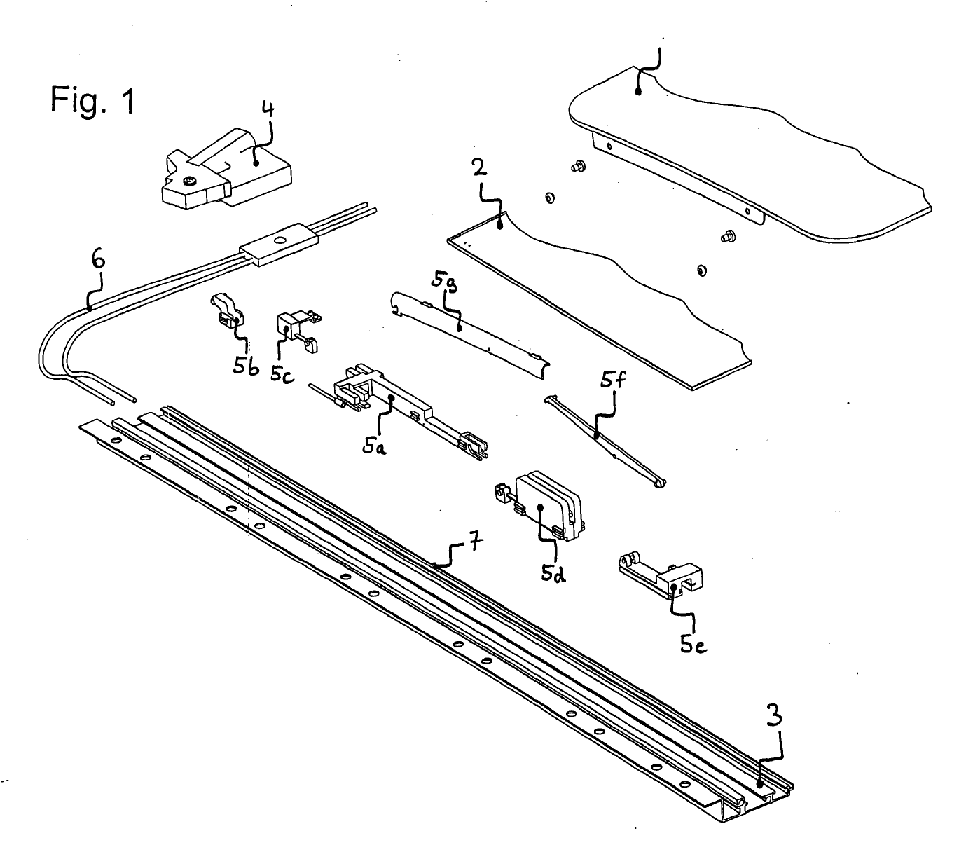

FIG. 1 is an isometric overall view of the components of the roof opening system according to the invention;

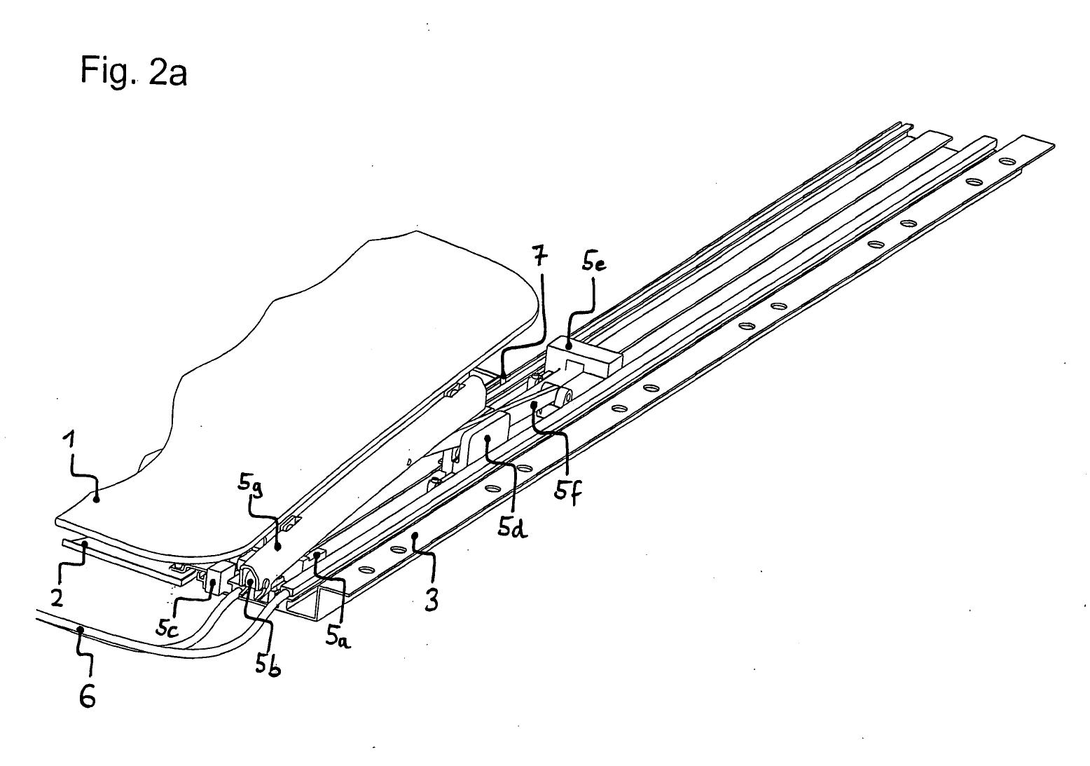

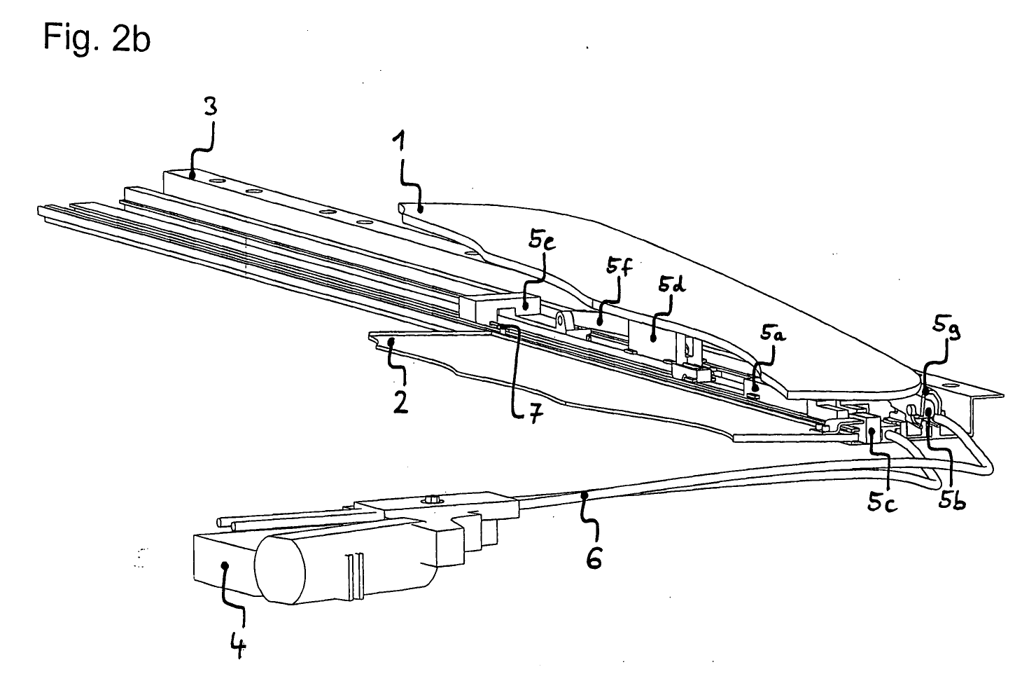

FIG. 2a illustrates a roof opening system according to the invention in the initial position;

FIG. 2b is a further illustration of a roof opening system according to the invention in the initial position;

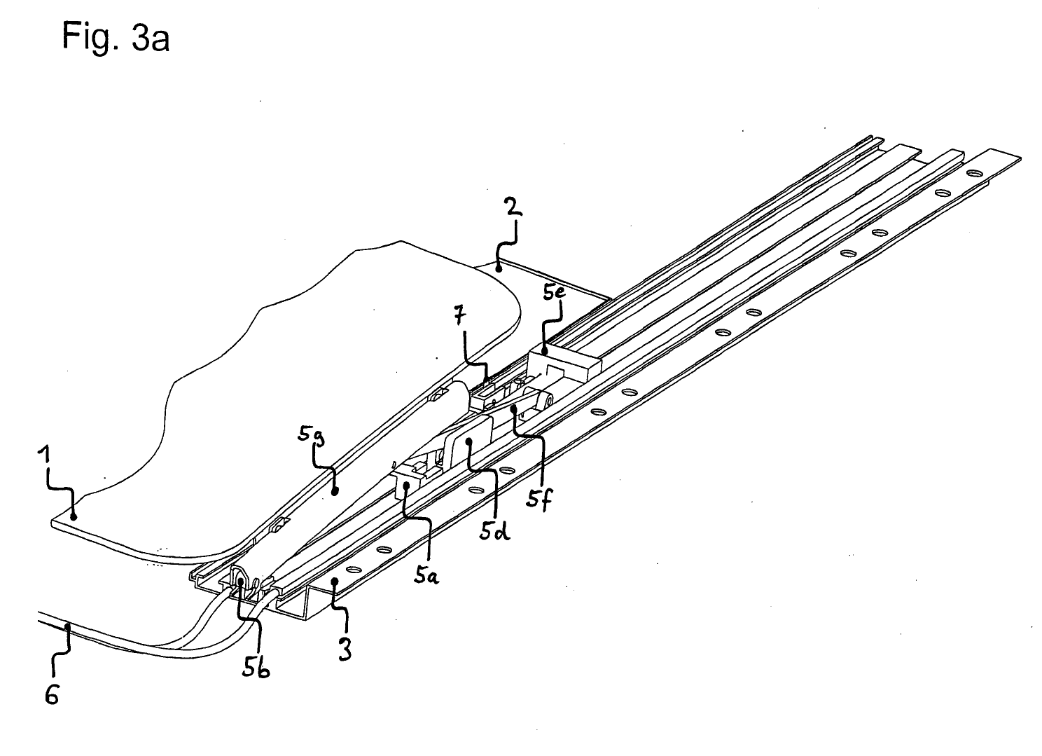

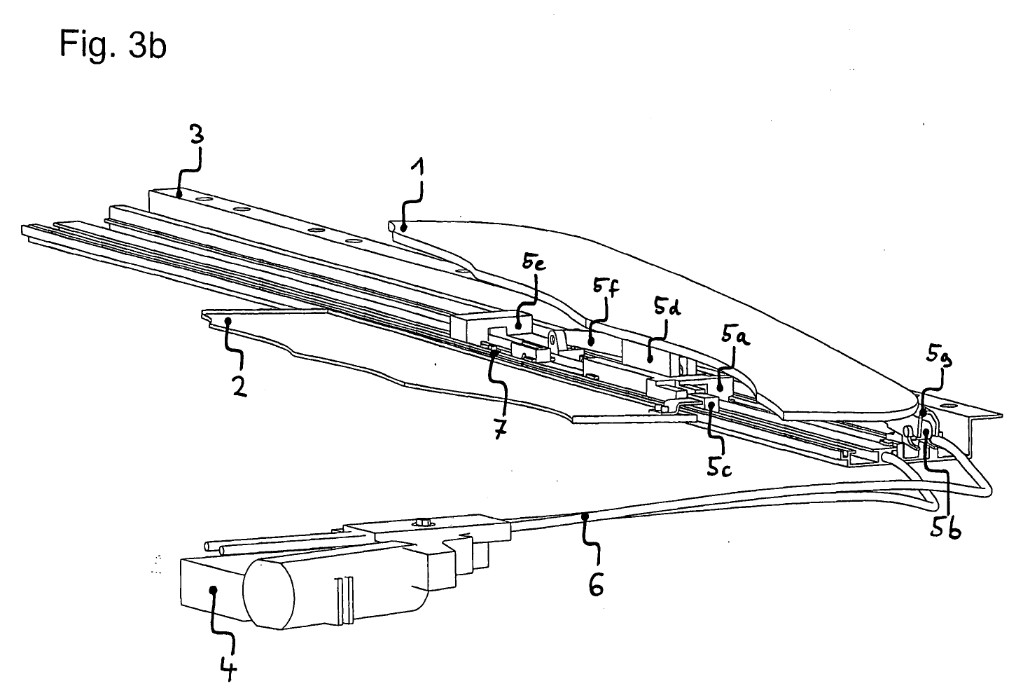

FIG. 3a shows the same as in FIG. 2a, but with a shifted shade element;

FIG. 3b shows the same as in FIG. 3a in a different view;

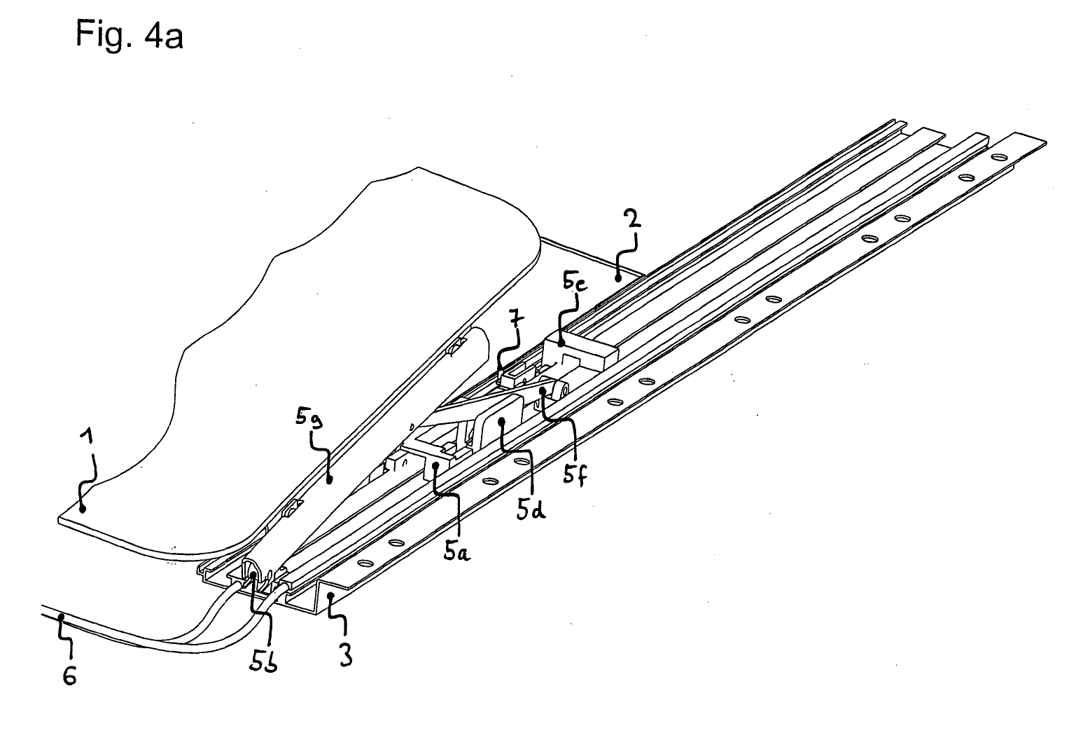

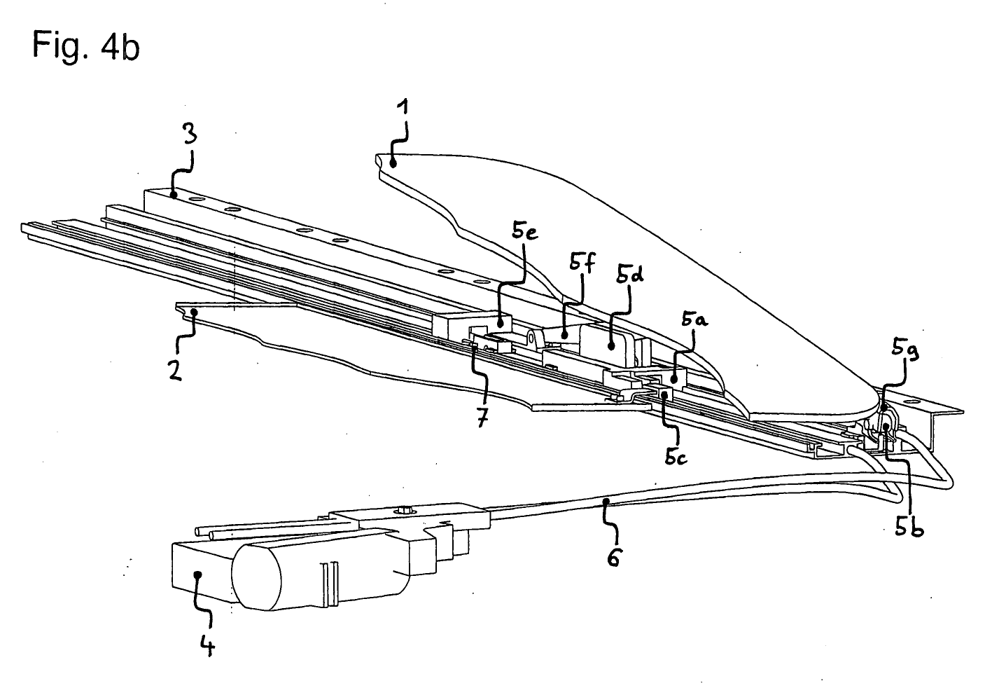

FIG. 4a shows the same as in FIG. 3a, but in a further possible position;

FIG. 4b shows the same as in FIG. 4a in a different view;

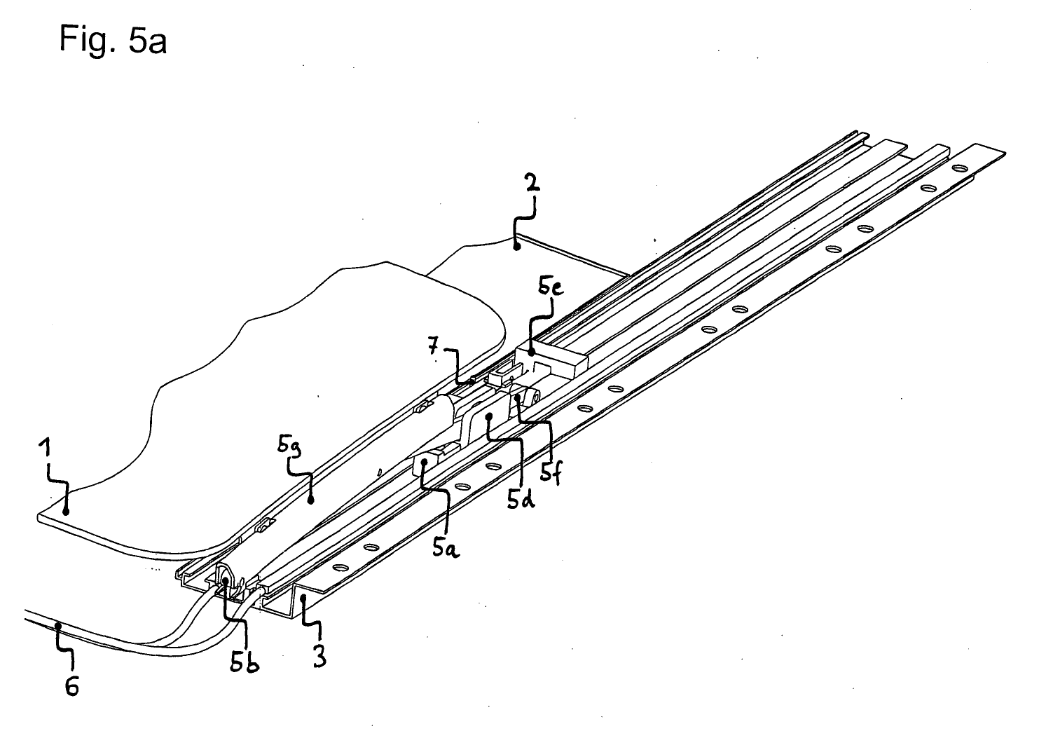

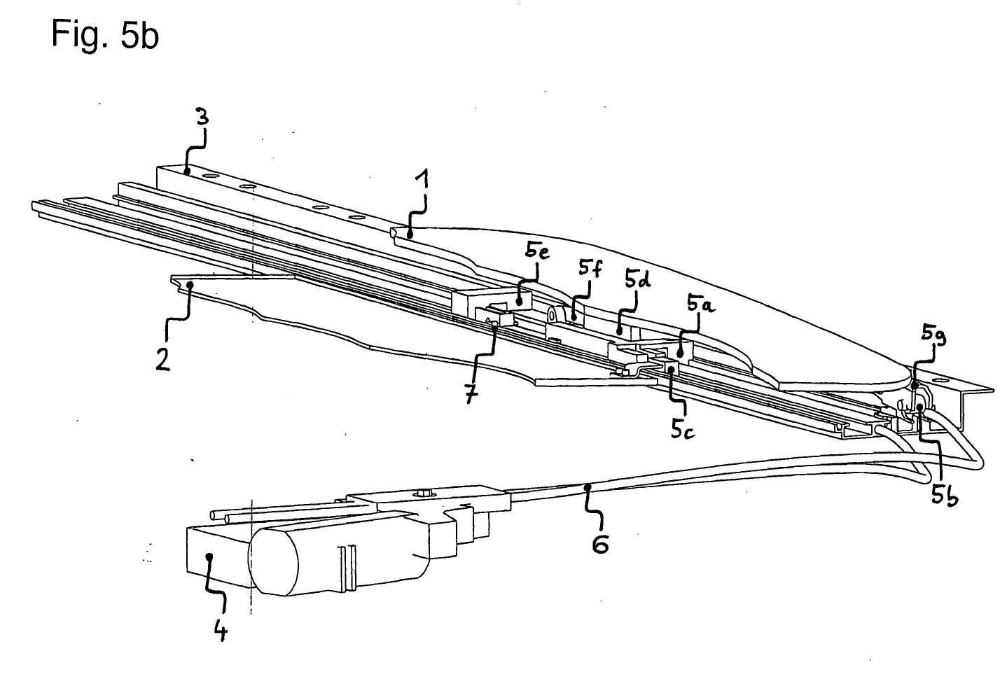

FIG. 5a shows the same as in FIG. 4a, but in a further possible position;

FIG. 5b shows the same as in FIG. 5a in a different view;

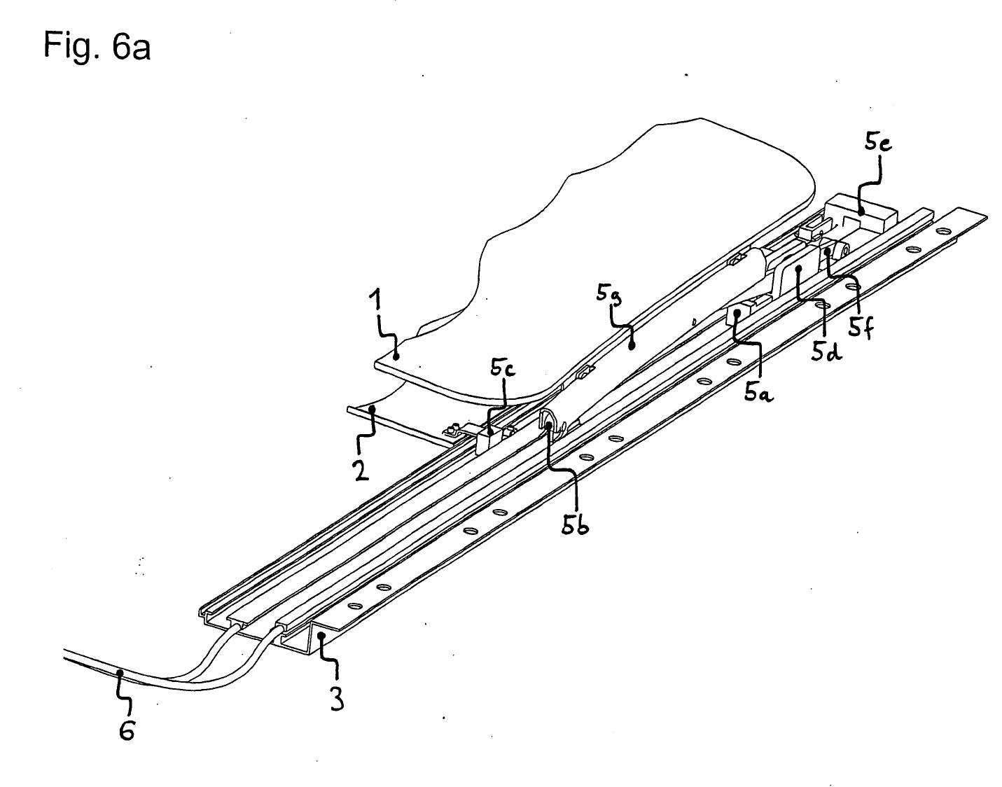

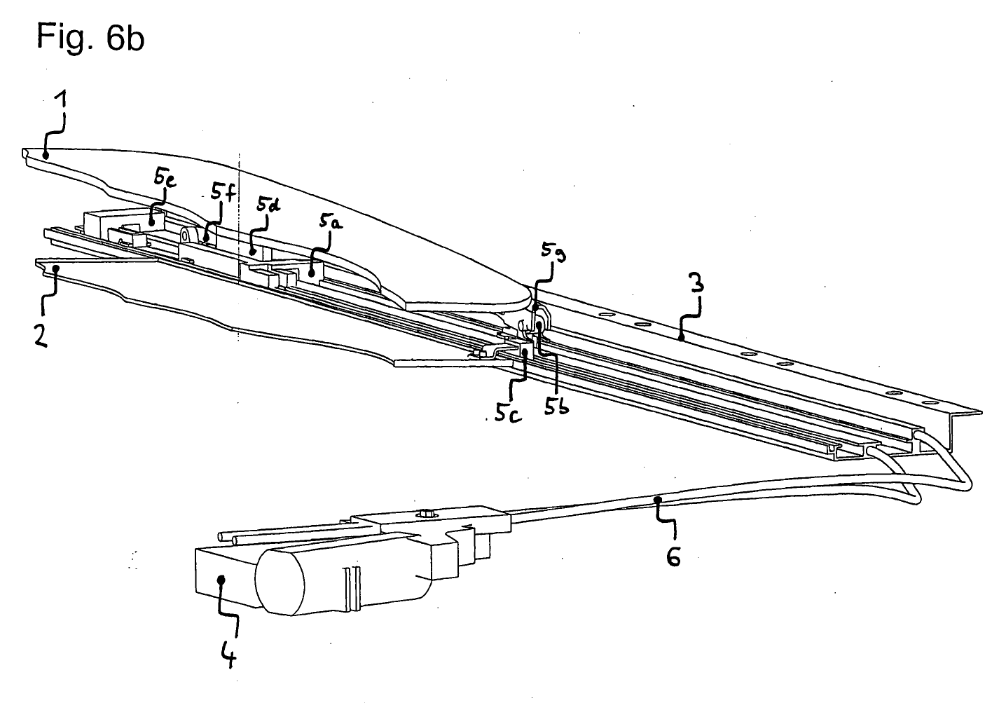

FIG. 6a shows the same as in FIG. 5a, but in a further possible position;

FIG. 6b shows the same as in FIG. 6a in a different view;

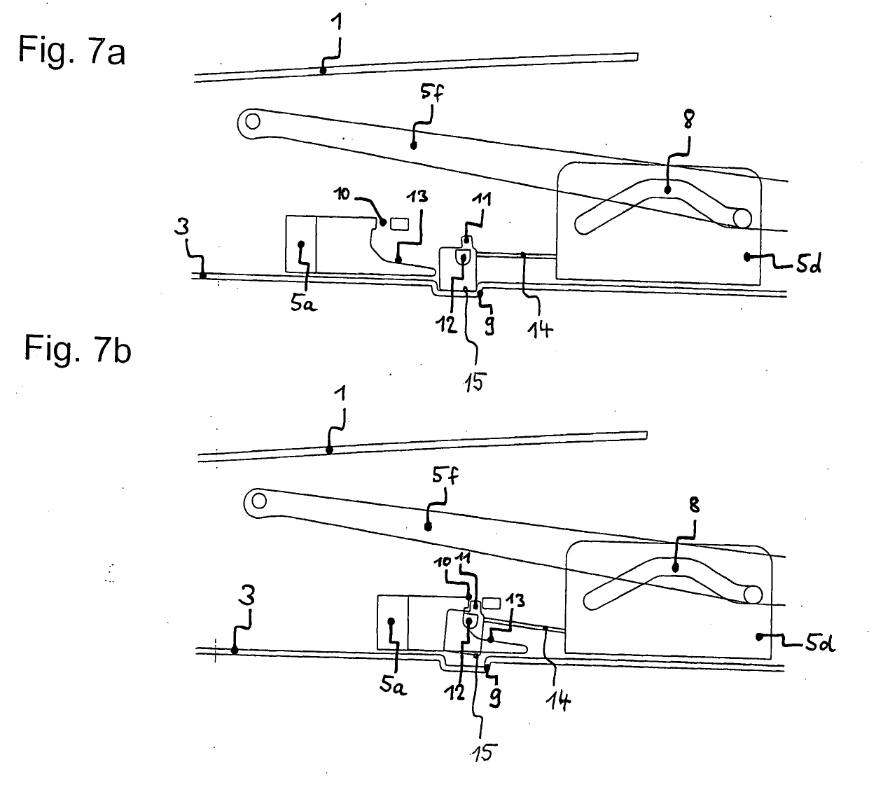

FIGS. 7a, b illustrate a detail of a locking unit in the installed state;

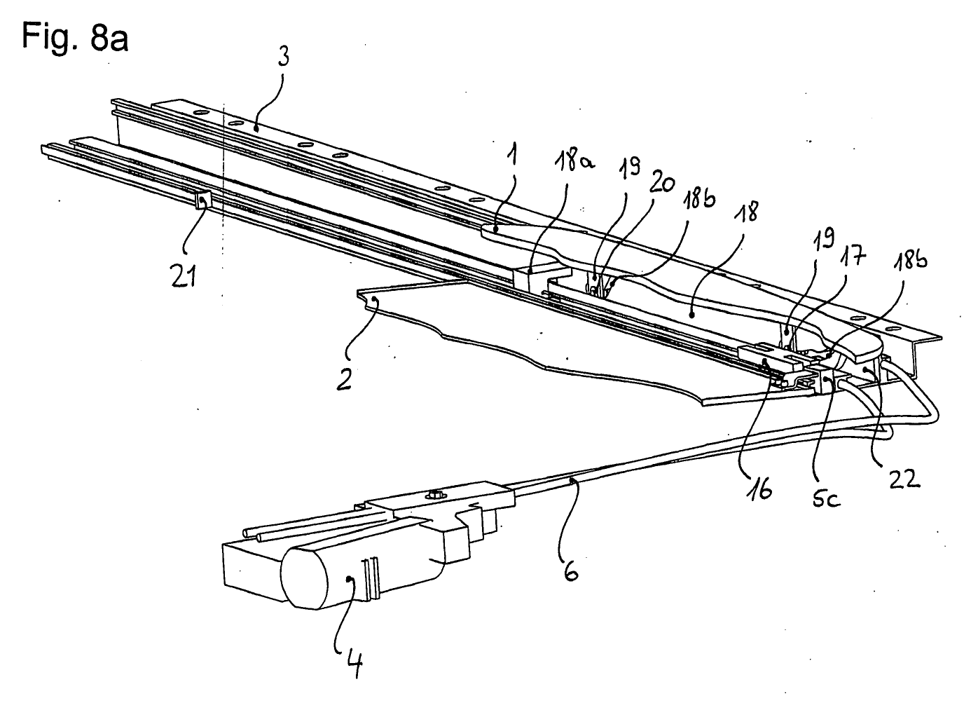

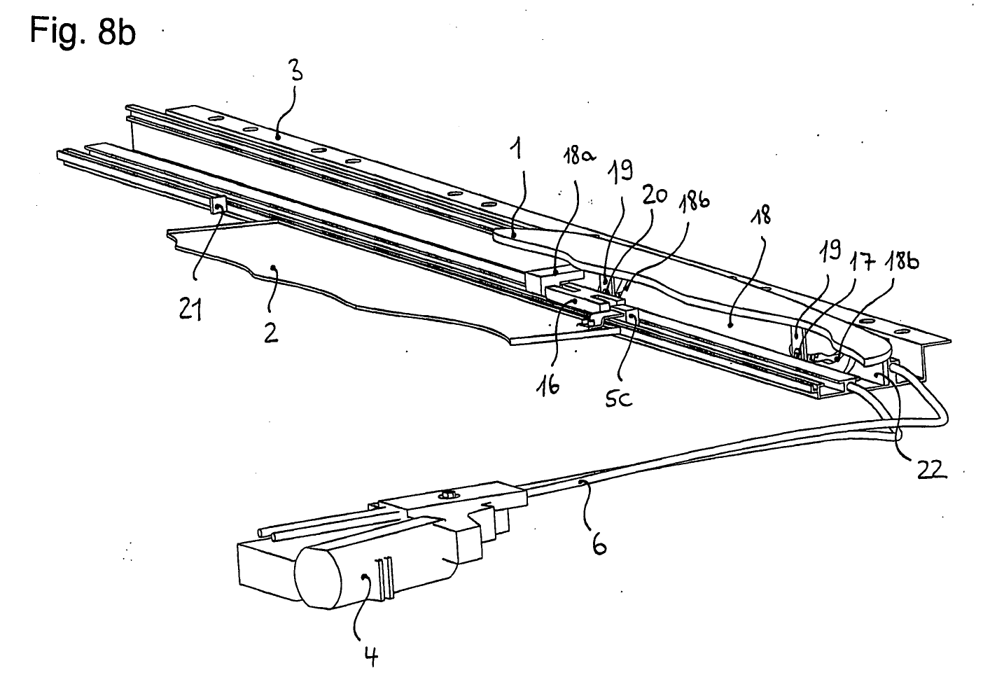

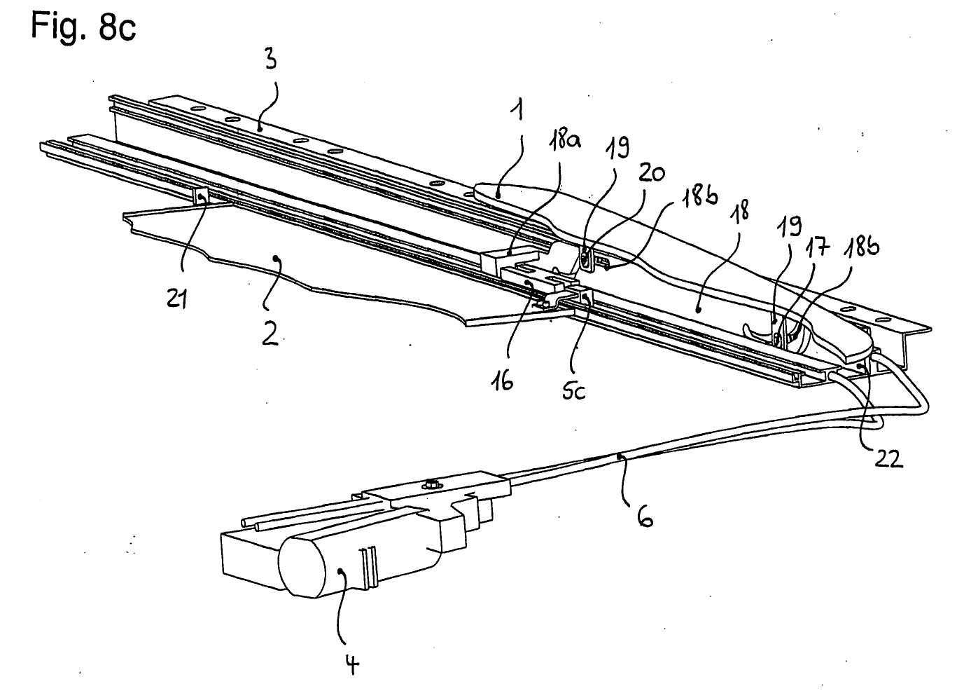

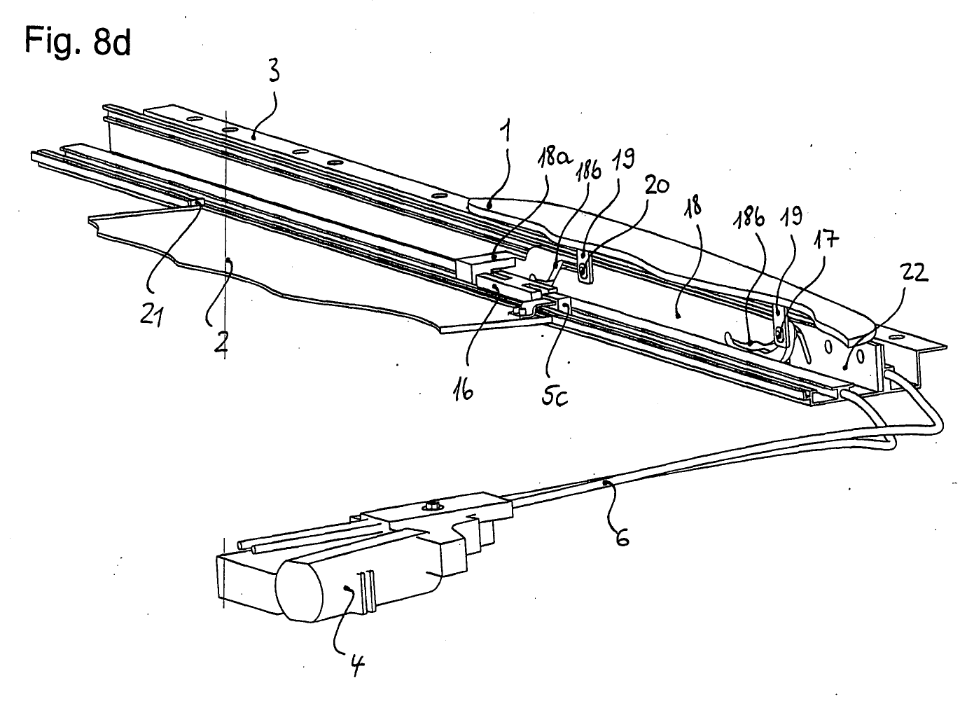

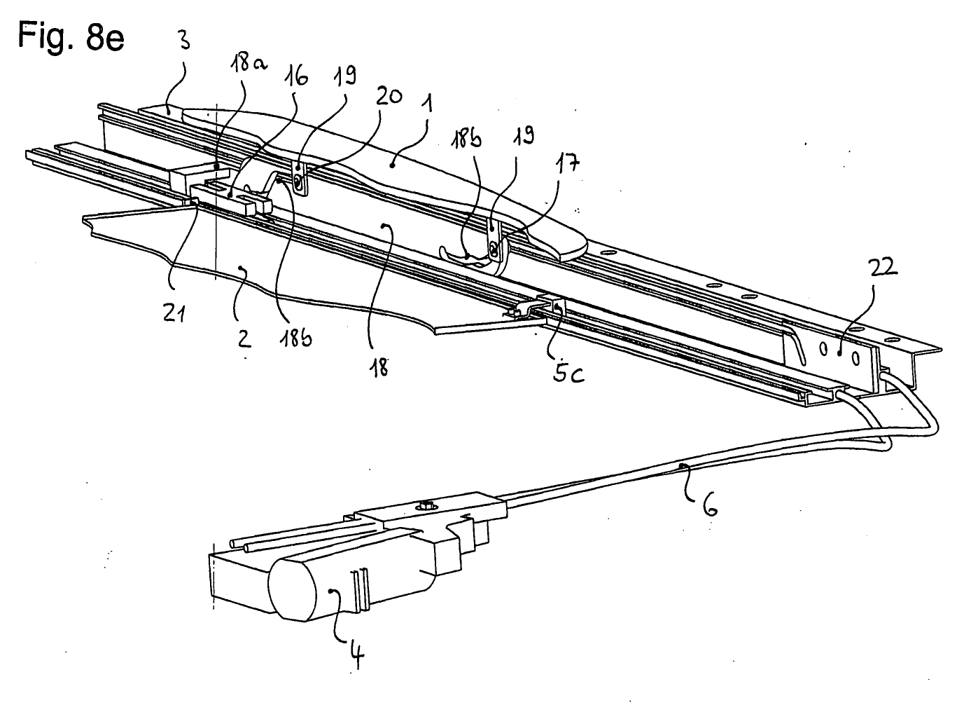

FIG. 8a shows a variant of the illustration of a roof opening system according to the invention in the initial position;

FIG. 8b shows the same as in FIG. 8a, but with a shifted shade element in a first position variant;

FIG. 8c shows the same as in FIG. 8b, second position variant;

FIG. 8d shows the same as in FIG. 8c, third position variant; and

FIG. 8e shows the same as in FIG. 8a, but in a possible end position.

FIG. 1 shows an isometric overall view of the components of the roof opening system according to the invention. The parts are here shown such that they can be made out in detail.

FIG. 2a illustrates a roof opening system according to the invention in the initial position. In this particularly preferred variant, the vehicle cover 1 closes the roof opening of the vehicle. The shade element 2 is also in the closed position. The drive element 5a is coupled with the shade guide 5c, which in turn is always firmly connected to the shade element 2. The drive element 5a is always firmly connected to a drive cable 6. The drive element 5a and the shade guide 5c are slidably supported in the rigid guide element 3. In this illustrated position, the vehicle cover 1 is locked via the vehicle cover connection element 5g, the vehicle-cover movable bearing 5b, the control rod 5f, the vehicle-cover control element 5d and the vehicle-cover locking element 5e in the rigid guide element 3.

FIG. 2b is a further illustration of a roof opening system according to the invention in the initial position as illustrated in FIG. 2a, in a different view.

FIG. 3a shows the same as FIG. 2a, but with the shade element 2 being shifted. In this particularly preferred variant, the vehicle cover 1 closes the roof opening of the vehicle. The shade element 2, shifted by the drive element 5a, is now in a partly opened position.

FIG. 3b shows the same as FIG. 3a in a different view.

FIG. 4a shows the same as FIG. 3a, but in a further possible position. In this particularly preferred variant, the shade element 2 is further shifted by the drive element 5a. The drive element 5a unlocks the vehicle-cover control element 5d from the rigid guide element 3 by way of coupling. In this process, the vehicle cover 1 pivots relative to the roof opening of the vehicle to position the rear edge of the vehicle cover above the vehicle roof. This movement of the vehicle cover 1 is made possible by the movable bearing in the vehicle-cover movable bearing 5b and by the pivotal movement of the control rod 5f. The pivotal movement of the control rod 5f is carried out through the form-fit engagement of the control rod 5f in the control path 8, which is part of the vehicle-cover control element 5d (see also FIGS. 7a, b).

FIG. 4b shows the same as FIG. 4a in a different view.

FIG. 5a shows the same as FIG. 4a, but in a further possible position. In this particularly preferred variant, the shade element 2 is further shifted by the drive element 5a. The vehicle cover 2 pivots here relative to the roof opening of the vehicle to position the rear edge of the vehicle cover underneath the vehicle roof. This movement is made possible by the special design of the control path 8.

FIG. 5b shows the same as FIG. 5a in a different view.

FIG. 6a shows the same as FIG. 5a, but in a further possible position. In this particularly preferred variant, the further movement of the shade element 2 is limited by the stop 7, which can be seen in FIGS. 1 to 5b. The shade guide 5c is here decoupled from the drive element 5a and locked in the rigid guide element 3. Due to the special design of the control path 8, the vehicle cover 1 is now in a position that is of advantage to the further displacement. The drive element 6a unlocks the vehicle-cover locking element 5e from the rigid guide element 3 by way of coupling. In the further motion sequence of the drive element 5a, the vehicle cover 1 can be shifted further until the intended position is reached. By reversal of the direction of movement of the drive element 5a, the vehicle cover 1 and the shade element 2 pass through the illustrated motion sequence in reverse order and are returned into the initial position.

FIG. 6b shows the same as FIG. 5a in a different view.

In a particularly preferred variant, FIG. 7a shows a detail variant of a locking/coupling system in the installed state. It is shown in this position how the vehicle-cover control element 5d is fixed by means of the lower locking nose 15 in the rigid guide element 3. If, as shown in FIG. 7b, the drive element 5a is moved towards the vehicle-cover control element 5d, the lock slide 12 slides over the slide ramp 13 and is lifted against the force of spring 14 out of the locking recess 9. The upper locking nose 11 is here pushed into the locking window 10 and couples the drive element 5a to the vehicle-cover control element 5d. This coupling permits a shifting in both directions along the rigid guide element 3. A stop, which at a suitable position in the rigid guide element 3 defines the direction of movement during closing of the vehicle cover 1, locks the lower locking nose 15, biased by the force of spring 14, into the locking recess 9. Upon displacement of the vehicle-cover control element 5d with the control path 8 in the rigid guide element 3, the control rod 5f, which is firmly supported in the vehicle-cover locking element 5e, performs a relative movement with which a lifting/lowering of the vehicle cover 1 is accomplished.

FIG. 8a shows a variant of the illustration of a roof opening system according to the invention in the initial position. In this particularly preferred variant, only two coupling and/or locking operations are required. Shown are the vehicle cover 1 and the shade element 2, each in the closed position. The vehicle cover 1 comprises further vehicle-cover connection elements 19 to which a slide bolt 20 or a control bolt 17 is secured. The control bolt 17 is slidingly supported via the path element 18 in the rigid guide element 3 and the cover control path.

FIG. 8b shows the same as FIG. 8a, but with a displaced shade element 2 in a first position variant. In this position variant, the shade element 2 is partly displaced by the further drive element 16, which is coupled to the shade guide 5c. The drive element 16 couples to the further vehicle-cover locking element 18a and unlocks the same from the rigid guide element 3. The further vehicle-cover locking element 18a is connected to the path element 18 and slidably supported in the rigid guide element 3 and in the cover control path 22. In this position, the vehicle cover 1 is still secured via the slide bolt 20 in the cover control path 22 against displacement, but is moved by the path element 18 relative to the guide element 3. The path element 18 and the cover control path 22 effect a relative movement which permits a lifting/lowering of the vehicle cover 1.

FIG. 8c shows the same as FIG. 8b in a second position variant. The shade element 2 is shifted further. The path element 18 and the cover control path 22 effect a further relative movement which permits a lifting/lowering of the vehicle cover 1 into a fan position.

FIG. 8d shows the same as FIG. 8c in a third position variant. The vehicle cover 1 is moved by the path element 18 further relative to the rigid guide element 3. The position enables the control bolt 17 and thus the vehicle cover 1 to be shifted along the cover control path 22 and the rigid guide element 3. The shade element 2 has reached a possible end position and is prevented by the further stop 21 from being shifted further. The shade guide 5c simultaneously locks into the rigid guide element 3. In this position, the shade element 2 is secured in the possible end position against displacement in both directions along the rigid guide element 3.

FIG. 8e shows the same as FIG. 8a, but in a possible end position. The vehicle cover 1 has been shifted by the further vehicle-cover locking element 18a along the cover control path 22 and has reached a possible end position.

The invention has been described with reference to a particular embodiment. However, it goes without saying that changes and alterations can be made without departing from the scope of protection of the following claims.

### LIST OF REFERENCE NUMERALS

1 Vehicle cover
2 Shade element
3 Rigid guide element
4 Electric drive
5 Movable control elements
5a Drive element
5b Vehicle-cover movable bearing
5c Shade guide
5d Vehicle-cover control element
5e Vehicle-cover locking element
5f Control rod
5g Vehicle-cover connection element
6 Drive cable
7 Stop
8 Control path
9 Locking recess
10 Locking window
11 Locking nose top
12 Locking slide
13 Slide ramp
14 Spring
15 Locking nose bottom
16 Drive element
17 Control bolt
18 Path element
18a Vehicle-cover locking element
18b Cover movement path
19 Vehicle-cover connection element
20 Slide bolt
21 Stop
22 Cover control path

1. A roof opening system for automotive vehicles, comprising at least one at least partly transparent vehicle cover and at least one shade element, wherein an electric drive associated with the at least one of said partly transparent vehicle covers and at least one shade element are each movable independently of each other over a roof opening area provided in the vehicle.

2. The roof opening system according to claim 1, wherein the movements of the at least one vehicle cover and the at least one shade element take place relative to at least one rigid guide element.

3. The roof opening system according to claim 2, wherein the at least one vehicle cover is movable along the at least one rigid guide element or is pivotable relative to the at least one rigid guide element.

4. The roof opening system according to claim 1, wherein the electric drive for opening and closing the at least one vehicle cover and the at least one shade element has only one respective direction of rotation and effects a linear movement of at least one drive element by means of a drive cable.

5. The roof opening system according to claim 4, wherein the at least one drive element is configured such that it performs exactly three respective coupling and/or locking operations for the opening or closing action.

6. The roof opening system according to claim 1, wherein the at least one shade element comprises at least one shade guide.

7. The roof opening system according to claim 6, wherein the shade guide is configured to be lockable in the rigid guide element and coupleable to at least one drive element.

8. The roof opening system according to claim 1, wherein an area of the front edge of the vehicle cover of the at least one vehicle cover is movably supported in at least one rigid guide element by means of at least one vehicle-cover movable bearing.

9. The roof opening system according to claim 1, wherein the at least one vehicle cover comprises at least one detachable fixed bearing.

10. The roof opening system according to claim 9, wherein at least one control rod is rotatably supported in the at least one fixed bearing of the at least one vehicle cover, said fixed bearing being detachable in the rigid guide element.

11. The roof opening system according to claim 10, wherein the at least one control rod is rotatably supported in at least one vehicle-cover locking element.

12. The roof opening system according to claim 11, wherein the at least one vehicle-cover locking element is configured to be lockable in the at least one rigid guide element and coupleable with the at least one drive element.

13. The roof opening system according to claim 10, further comprising a vehicle-cover control element, the at least one control rod and the at least one vehicle-cover control element are configured such that they engage each other in form-fit fashion.

14. The roof opening system according to claim 13, wherein the at least one vehicle-cover control element is slidingly supported in the at least one rigid guide element.

15. The roof opening system according to claim 13, wherein the at least one vehicle-cover control element is configured to be lockable in the at least one rigid guide elements and coupleable with the at least one drive element.

16. The roof opening system according to claim 13, wherein the at least one vehicle-cover control element comprises the at least one control path.

17. The roof opening system according to claim 13, wherein the at least one control rod comprises at least one control path.

18. The roof opening system according to claim 1, wherein the at least one drive element is moved by the one electric drive along the at least one rigid guide element.

19. The roof opening system according to claim 13, wherein the at least one drive element is configured such that it interacts by way of coupling and decoupling with the at least one shade guide, at least the one vehicle-cover control element and the at least one vehicle-cover locking element.

20. The roof opening system according to claim 1, wherein exactly two coupling and/or locking operations are required for a respective movement cycle opening or closing of the at least one vehicle cover and/or at least one shade element.

21. The roof opening system according to claim 20, wherein the shade guide (5c) is configured to be lockable in the rigid guide element and coupleable with at least one drive element (16).

22. The roof opening system according to claim 20, wherein the at least one vehicle cover is connected to at least one vehicle-cover connection element.

23. The roof opening system according to claim 20, wherein at least one path element is guided in the at least one rigid guide element.

24. The roof opening system according to claim 23, wherein at least one vehicle-cover locking element is part of the at least one path element.

25. The roof opening system according to claim 23, wherein the at least one path element comprises at least one cover movement path.

26. The roof opening system according to claim 24, wherein the at least one vehicle-cover locking element is configured to be lockable in the at least one rigid guide element.

27. The roof opening system according to claim 24, wherein the at least one vehicle-cover locking element is configured to be coupleable with the at least one drive element.

28. The roof opening system according to claim 22, wherein at least one vehicle-cover connection element is guided in form-fit fashion with at least one slide bolt and at least one control bolt in the at least one cover movement path.

29. The roof opening system according to claim 28, wherein the at least one control bolt is guided in form-fit fashion in the at least one rigid guide element and in at least one cover control path.
